(19) United States
(12) Patent Application Publication
(10) Pub. No.: US 2022/0188551 A1
(43) Pub. Date: Jun. 16, 2022

(54) ACTIVITY RECOGNITION BASED ON IMAGE AND COMPUTER-READABLE MEDIA

(71) Applicant: INDUSTRIAL TECHNOLOGY RESEARCH INSTITUTE, Hsinchu (TW)

(72) Inventors: Guan-Han ZHU, Changhua County (TW); Jin-Shyan LEE, Kaohsiung City (TW); Chun-Hsien WU, Taichung City (TW); Orlando Salvador HABET, Hsinchu County (TW); Jui-Wen CHEN, Taoyuan City (TW); Hung-Hsiang CHEN, Tainan City (TW)

(73) Assignee: INDUSTRIAL TECHNOLOGY RESEARCH INSTITUTE, Hsinchu (TW)

(21) Appl. No.: 17/135,819

(22) Filed: Dec. 28, 2020

(30) Foreign Application Priority Data
Dec. 11, 2020 (TW) 109143844

(51) Int. Cl. G06K 9/00

(52) U.S. Cl. CPC G06K 9/00771; G06K 9/00335

(57) ABSTRACT

An activity recognition method and a computer-readable media are disclosed. The activity recognition method is applied to an activity recognition system configured to recognize several activities. The activity recognition method includes: obtaining an original activity image corresponding to a first time point, wherein the original activity image includes several pixels indicating whether several sensors are triggered; determining an image feature according to a second activity corresponding to a second time point, wherein the second time point is prior to the first time point; integrating the original activity image and the image feature to generate a characteristic activity image; and determining a first activity corresponding to the first time point according to the characteristic activity image.

This application claims the benefit of Taiwan application Serial No. 109143844, filed Dec. 11, 2020, the disclosure of which is incorporated by reference herein in its entirety.

### TECHNICAL FIELD

The disclosure relates in general to an activity recognition method based on image and a computer-readable media.

### BACKGROUND

A smart living environment indeed provides convenience and safety to the solitary people. In a smart living environment, activity recognition can be done through the sensors installed at different places of the house. A resident's activity can be recognized according to which sensor/sensors is/are triggered. Since some different activities may trigger similar sensors, the differentiation of different activities becomes difficult. Therefore, how to increase recognition accuracy has become a prominent task for the industries.

### SUMMARY

According to one embodiment, an activity recognition method applied to an activity recognition system configured to recognize several activities is disclosed. The activity recognition method includes: obtaining an original activity image corresponding to a first time point, wherein the original activity image includes several pixels indicating whether several sensors are triggered; determining an image feature according to a second activity corresponding to a second time point, wherein the second time point is prior to the first time point; integrating the original activity image and the image feature to generate a characteristic activity image; and determining a first activity corresponding to the first time point according to the characteristic activity image.

According to another embodiment, a computer-readable media is disclosed. When the computer-readable media is performed by a processing unit of an activity recognition system configured to recognize several activities, the processing unit is enabled to: obtain an original activity image corresponding to a first time point, wherein the original activity image includes several pixels indicating whether several sensors are triggered; determine an image feature according to a second activity corresponding to a second time point, wherein the second time point is prior to the first time point; integrate the original activity image and the image feature to generate a characteristic activity image, and determine a first activity corresponding to the first time point according to the characteristic activity image.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a block diagram of an activity recognition system according to an embodiment of the present invention.

FIG. 2 is a flowchart of an activity recognition method according to an embodiment of the present invention.

FIG. 3 is a flowchart of a correspondence method between image features and activities according to an embodiment of the present invention.

FIG. 4 is a flowchart of corresponding each activity to a unique image feature according to an arrangement sequence and a probability distribution of the previous activity of each activity.

FIG. 5 is an illustrative example of integrating the original activity image and the image feature according to an embodiment of the present invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

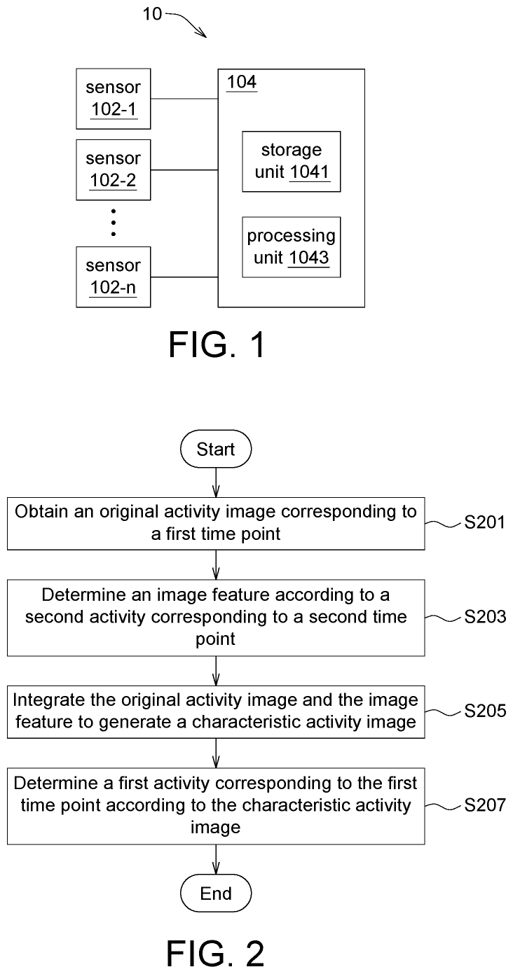

Referring to FIG. 1, a block diagram of an activity recognition system according to an embodiment of the present invention. The activity recognition system 10 includes several sensors 102-1˜102-n and a computing module 104. The sensors 102-1˜102-n may include temperature sensors, sound sensors, light sensors, infrared sensors, and/or pressure sensors. The sensors 102-1˜102-n can be installed at different places of the house. For example, the infrared sensor can be installed above the entrance to detect whether anyone is passing through the entrance, installed on the inner side of the door frame of the entrance to detect whether the door is opened, or installed on the sofa to detect whether anyone is sitting on the sofa. In an embodiment, the activity recognition system 10 can recognize human activities.

The computing module 104 includes a storage unit 1041 and a processing unit 1043. The storage unit 1041 can be any type of fixed or movable memory, such as random access memory (RAM), read-only memory (ROM), flash memory, phase-change memory, hard disk drive (HDD), register, solid-state drive (SSD), other similar elements or a combination of the above elements. The processing unit 1043 can be a central processing unit (CPU), programmable general or special purpose micro control unit (MCU), microprocessor, digital signal processor (DSP), programmable controller, application-specific integrated circuit (ASIC), graphics processing unit (GPU), arithmetic logic unit (ALU), complex programmable logic device (CPLD), field-programmable gate array (FPGA), other similar elements or a combination of the above elements.

In an embodiment, at several time points, each of the sensors 102-1˜102-n transmits a signal to the computing module 104 according to whether the sensor is triggered at the time point. At each time point, the computing module 104 records which of sensors 102-1˜102-n are triggered and/or which are not triggered to generate a sensing record corresponding to the time point, wherein two adjacent time points are separated by a sampling interval. The sensing record can be stored in the storage unit 1041 of the computing module 104. The processing unit 1043 of the computing module 104 generates an original activity image according to each sensing record. For example, at a first time point, the computing module 104 obtains a first sensing record through the sensors 102-1˜102-n and generates a first original activity image according to the first sensing record; at a second time point, the computing module 104 obtains a second sensing record through the sensors 102-1˜102-n and generates a second the original activity image according to the second sensing record.

The original activity image can be stored in the storage unit 1041. The original activity image can be a dot matrix including several pixels corresponding to the several sensors 102-1˜102-n. For example, the number of sensors 102-1˜102-n is 50, and the size of the original activity image can be 10 pixels long by 10 pixels wide, wherein 50 of the 100 pixels of the original activity image one-to-one correspond to the sensors 102-1˜102-n, the pixels corresponding to the sensors triggered at the time point can be denoted by a first color (such as black), and the pixels corresponding to the sensors not triggered at the time point can be denoted by a second color (such as white).

The activity recognition system 10 can be configured to recognize several activities, such as “Go Home”, “Go Out”, “Cook”, “Wash Dishes”, “Have Meal”, “Rest”, “Sleep”, “Take Bath”, and “Watch TV”. The number of recognizable activities depends on the activity recognition system 10. In an embodiment, the activity recognition system 10 has a higher recognition ability and can recognize 10 different activities. In another embodiment, the activity recognition system 10 has lower recognition ability and can recognize only 6 different activities.

When several different activities trigger similar sensors, the corresponding activity images may have a large similarity, and activity determination based on activity images may become confused. For example, “Go Out” and “Go Home” are two different activities. When the two different activities trigger similar sensors, “Go Out” may be mis-determined as “Go Home”, or “Go Home” may be mis-determined as “Go Out”. The activity recognition method disclosed in the embodiments of the present invention can effectively avoid the above instances.

Referring to FIG. 2, a flowchart of an activity recognition method according to an embodiment of the present invention is shown. In an embodiment, a computer-readable media including several computer-readable commands can be used to implement the activity recognition method. The computer-readable media may be included in the storage unit 1041. When the computer-readable media is performed by the processing unit 1043, the processing unit 1043 can perform the activity recognition method. The activity recognition method can be applied to the activity recognition system 10, and the computer-readable media can be stored in the storage unit 1041.

Firstly, the method begins at step S201, an original activity image corresponding to a first time point is obtained. Detailed descriptions of the original activity image can be obtained with reference to the above disclosure. In an embodiment, the processing unit 1043 can access the storage unit 1041 to obtain the original activity image.

Next, the method proceeds to step S203, an image feature is determined according to a second activity corresponding to a second time point, wherein the second time point is prior to the first time point. For example, the second time point is prior to the first time point by a sampling interval. In an embodiment, the first time point and the second time point are sampling time points. Suppose the sampling interval is 1 second, then the second time point is 1 second before the first time point. That is, the second activity is an activity corresponding to the second time point recognized by the processing unit 1043 using the present method. The image feature may include one or more pixels, and can be any form, such as text, pattern, or color. The number of image features can be identical to the number of activities recognizable to the activity recognition system 10. For example, the activity recognition system 10 can recognize 10 different activities one-to-one corresponding to 10 different image features. That is, each activity corresponds to a unique image feature. In an embodiment, two different activities will not correspond to the same mage feature. In an embodiment, step S203 is performed before step S201.

Then, the method proceeds to step S205, the original activity image and the image feature are integrated to generate a characteristic activity image. In an embodiment, the processing unit 1043 replaces a part of the original activity image with an image feature to generate a characteristic activity image, that is, the size of the characteristic activity image is equivalent to that of the original activity image. In an embodiment, the processing unit 1043 attaches (or connects) an image feature to the original activity image to generate a characteristic activity image, that is, the size of the characteristic activity image is greater than the original activity image. For the present step to be better understood, the integration of the original activity image and the image feature is described with several practical examples below. In an embodiment, the image feature is a 2×2 square with a grayscale value (4 pixels). During the integration process, the processing unit 1043 replaces the pixels of the original activity image not used to represent the sensors, such as one of the four corners, with an image feature to generate a characteristic activity image. In another embodiment, the image feature is a column of pixels with a grayscale value. During the integration process, the processing unit 1043 connects the image feature to the topmost or bottommost column of pixels of the original activity image to generate a characteristic activity image. In an alternate embodiment, the image feature is formed of several pixels with an RGB value. During the integration process, the processing unit 1043 uses the image feature as an outer frame of the original activity image and attaches the image feature to the outer edge of the original activity image to generate a characteristic activity image. The above examples are for explanatory purposes only, not for limiting the scope of the present invention.

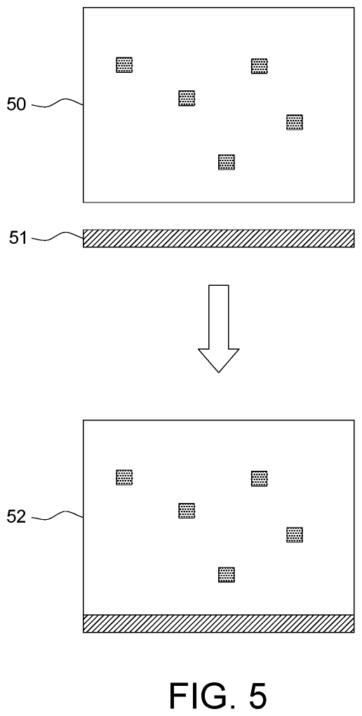

Referring to FIG. 5, an illustrative example of integrating the original activity image and the image feature according to an embodiment of the present invention is shown. In the present example, the image feature 51 is a column of pixels, and has a grayscale value corresponding to the corresponding activity. During the integration process, the image feature 51 is connected to the underneath of the original activity image 50 to generate a characteristic activity image 52.

Then, the method proceeds to step S207, a first activity corresponding to the first time point is determined according to the characteristic activity image. In an embodiment, the computer-readable media includes is used to implement one or more procedures, such as neural network procedures. The neural network can be used to determine the first activity corresponding to the first time point according to the characteristic activity image.

Through the above method, the image feature representing the second activity determined at the second time point prior to the first time point can be “added” to the activity image obtained at the first time point to generate a characteristic activity image. Thus, the characteristic activity image contains the image feature representing the previous activity, and the accuracy of determining the current activity will be increased if the previous activity can be taken into consideration. Particularly, when the current activity is one of two different activities such as “Go Home” and “Go Out” that trigger similar sensors. As the previous activity is taken into consideration, the probability of mis-determination can be effectively reduced.

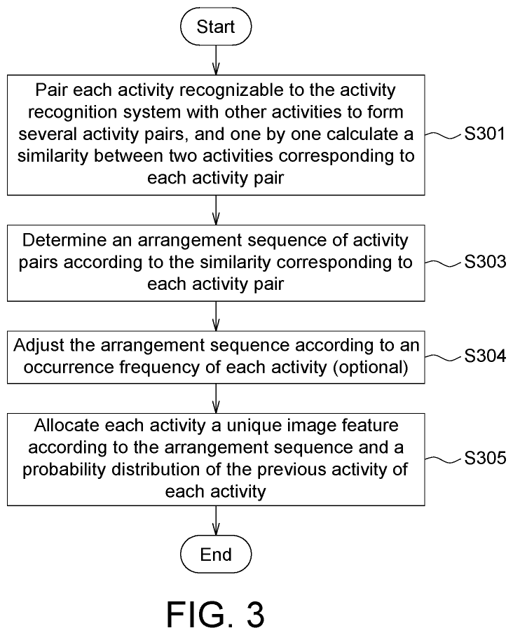

FIG. 3 is a flowchart of a correspondence method between image features and activities according to an embodiment of the present invention. The generation of a correspondence relation between image features and activities is described below with FIG. 3. In an embodiment, the image features corresponding to the activities are selected from several candidate image features.

Firstly, the method begins at step S301, each activity recognizable to the activity recognition system is paired with other activities by the activity recognition system to form several activity pairs, and a similarity between two activities corresponding to each activity pair is calculated one by one. In an embodiment, the similarity between two activities refers to a parameter generated by quantifying the overlapping situation between the sensor triggered by one of the two activities and the sensor triggered by the other one of the two activities. That is, similarity represents the degree of overlapping between the sensors triggered by two activities, and the larger the degree of overlapping, the larger the similarity. In an embodiment, the similarity between two activities is calculated using cosine similarity. In another embodiment, any mathematical tools that can be used to quantify the degree of similarity between the sensors triggered by two activities are used to calculate similarity.

For example, suppose the activity recognition system can recognize 6 activities, namely “Go Home”, “Go Out”, “Cook”, “Wash Dishes”, “Rest”, and “Sleep”. The activity pairs include “Go Home” pairing with other 5 activities, “Go Out” pairing with other 4 activities (“Go Home” pairing with “Go Out” is not repeated), “Cook” pairing with other 3 activities, and the rest activity pairs can be obtained by the same analogy. Thus, the activity pairs include [“Go Home”-“Go Out], [“Go Home”-“Cook”], [“Go Home”-“Wash Dishes”], [“Go Home”-“Rest”], [“Go Home”-“Sleep”], [“Go Out”-“Cook”], [“Go Out”-“Wash Dishes”], and the rest activity pairs can be obtained by the same analogy. When performing step S301, the similarity between two activities of each activity pair is calculated. In the above example, the similarity between “Go Home” and “Go Out”, the similarity between “Go Home” and “Cook”, the similarity between “Go Home” and “Wash Dishes”, the similarity between “Go Home” and “Rest”, the similarity between “Go Home” and “Sleep”, the similarity between “Go Out” and “Cook”, the similarity between “Go Out” and “Wash Dishes”, the similarity between “Go Out” and “Rest”, and the similarity between “Go Out” and “Sleep” are calculated, and the rest similarities can be obtained by the same analogy. The similarities can be represented by the similarity percentage in the form of Table 1 below:

TABLE 1

| | Go Home | Go Out | Cook | Wash Dishes | Rest | Sleep |
|---|---|---|---|---|---|---|
| Go Home | X | 95% | 10% | 13% | 43% | 16% |
| Go Out | 95% | X | 11% | 12% | 20% | 14% |
| Cook | 10% | 11% | X | 87% | 18% | 9% |
| Wash Dishes | 13% | 12% | 87% | X | 6% | 7% |
| Rest | 43% | 20% | 18% | 6% | X | 37% |
| Sleep | 16% | 14% | 9% | 7% | 37% | X |

Next, the method proceeds to step S303, an arrangement sequence of activity pairs is determined according to the similarity corresponding to each activity pair. In an embodiment, the arrangement sequence of activity pairs is determined according to the similarities sorted in descending order. In the above example, the similarities sorted in descending order are 95%, 87%, 43%, 37%, . . . , 7% and 6%. Thus, the arrangement sequence of activity pairs is: [“Go Home”-“Go Out”], [“Cook”-“Wash Dishes”], [“Go Home”-“Rest”], [“Rest”-“Sleep”], . . . , [“Sleep”-“Wash Dishes”], [“Rest”-“Wash Dishes”].

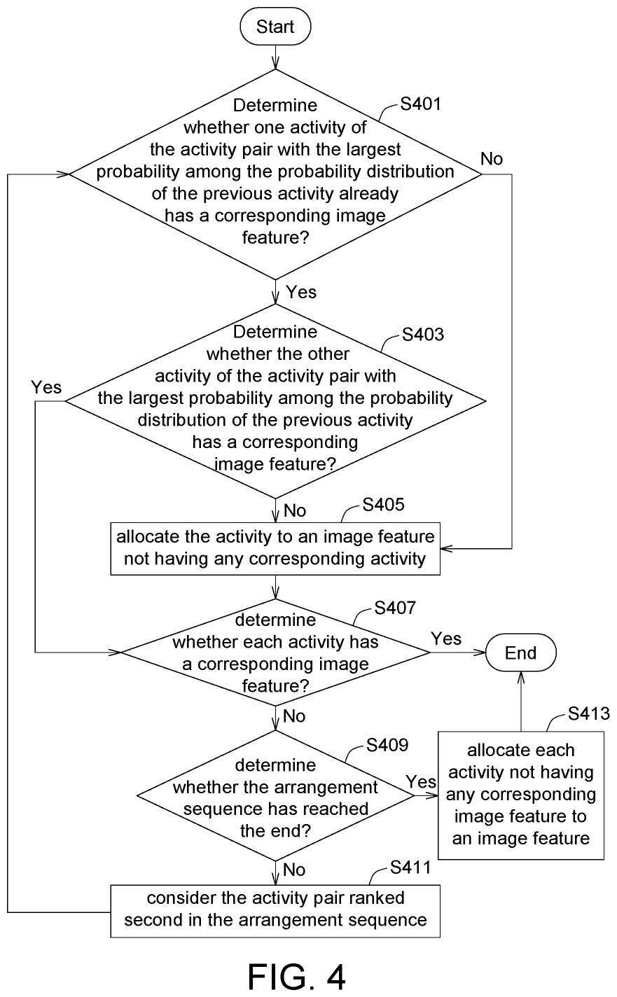

Then, the method proceeds to step S305, each activity is allocated to a unique image feature according to the arrangement sequence and a probability distribution of the previous activity of each activity. In an embodiment, the previous activity of each activity refers to the activity which occurred prior to the current activity by a sampling interval (that is, the activity which occurred at the previous time point). In an embodiment, the probability distribution of the previous activity of each activity can be obtained through observation and counting. For example, the activity “Go Home” is observed 1000 times and the frequency of the previous activity of the activity “Go Out” among the 1000 observations is counted. Suppose of the 1000 observations, the previous activity is observed as “Go Out” for 700 times and is observed as “Go Home” for 300 times. Then, the probability distribution of the previous activity of the activity “Go Home” is as follows: “Go Out” has a probability of 70%, and “Go Home” has a probability of 30%. The activity “Go Out” 1000 is observed 1000 times, and the frequency of the previous activity of the activity “Go Out” among the 1000 observations is counted. Suppose of the 1000 observations, the previous activity is observed as “Rest” for 540 times, is observed as “Wash Dishes” for 310 times, and is observed as “Go Home” for 150 times. Then, the probability distribution of the previous activity of the activity “Go Out” is as follows: “Rest” has a probability of 54%, “Wash Dishes” has a probability of 31%, and “Go Home” has a probability of 15%, and the probabilities of rest activities can be obtained by the same analogy. In an embodiment, when arranging the image features for activity pairs, the higher the rank in the arrangement sequence the higher the priority. Let the previous example be taken for example. In the arrangement sequence, the activity pair ranked first is [“Go Home”-“Go Out”] with a similarity of 95%, the activity pair ranked second is [“Cook”-“Wash Dishes”] with a similarity of 87%, and the activity pair ranked third is [“Go Home”-“Rest”] with a similarity of 43%. Therefore, when arranging the image features, the activity pair [“Go Home”-“Go Out”] has the first priority, the activity pair [“Cook”-Wash Dishes”] has the second priority, the activity pair [“Go Home”-“Rest”] has the third, priority, and the rest can be obtained by the same analogy. Details of step S305 can be obtained with reference to the flowchart of FIG. 4. After which activity pair is ranked first in the arrangement sequence is determined, the process can start with the activity pair ranked first in the arrangement sequence.

In step S401, whether one activity of the activity pair with the largest probability among the probability distribution of the previous activity already has a corresponding image feature is determined. If yes, the method proceeds to S403; otherwise, the method proceeds to S405.

In step S403, whether the other activity of the activity pair with the largest probability among the probability distribution of the previous activity has a corresponding image feature is determined. If yes, the method proceeds to S407; otherwise, the method proceeds to S405.

In step S405, the activity is allocated to an unmatched candidate image feature of several candidate image features and used as an image feature corresponding to the activity.

In step S407, whether each activity has a corresponding image feature is determined. If yes, the process terminates; otherwise, the process proceeds to step S409.

In step S409, whether the arrangement sequence has reached the end is determined. If yes, the process proceeds to S413; otherwise, the method proceeds to S411.

In step S411, the activity pair ranked second in the arrangement sequence is considered, and the process returns to S401.

In step S413, each unmatched activity is allocated to an unmatched candidate image feature of the image features.

The flowchart of FIG. 4 is described below with the above examples and candidate image features formed of 1 row (or 1 column) of pixels with different grayscale values. The grayscale values of the candidate image features are in a range of 0˜255 equally divided into the number of activities recognizable to the activity recognition system. If the activity recognition system can recognize 6 activities, the grayscale value can be divided into 6 values, namely 0, 51, 102, 153, 204, 255. That is, there are 6 candidate image features in total. Preferably, the two previous activities of the two activities of each activity are allocated to two image features whose grayscale values are poles apart, such as the image feature with the largest grayscale value and the image feature with the smallest grayscale value. Firstly, the activity pair [“Go Home”-“Go Out”] is considered. The activity “Go Out” has the largest probability among the previous activities of the activity “Go Home” of the activity pair [“Go Home”-“Go Out”], and the activity “Rest” has the largest probability among the previous activities of the activity “Go Out” of the activity pair [“Go Home”-“Go Out”]. Since none of “Go Out” and “Rest” has a corresponding image feature, the activity “Go Out” is allocated to a candidate image feature with a grayscale value of 255, and the activity “Rest” is allocated to a candidate image feature with a grayscale value of 0. Next, the activity pair [“Cook”-“Wash Dishes”] ranked second in the arrangement sequence is considered. Suppose the activity “Rest” has the largest probability among the previous activities of the activity “Cook” of the activity pair [“Cook”-“Wash Dishes”], and the activity “Cook” has the largest probability among the previous activities of the activity “Wash Dishes” of the activity pair [“Cook”-“Wash Dishes”]. Since the activity “Cook” still does not have a corresponding image feature, but the activity “Rest” already has a corresponding image feature with grayscale value 0, the activity “Cook” is allocated to a candidate image feature with a grayscale value of 204 which is farther away from the grayscale value of the image feature corresponding to the activity “Rest”, and the activity “Rest” uses the corresponding image feature with grayscale value 0. By the same analogy, steps S401˜S411 are repeated until all activities, namely “Go Home”, “Go Out”, “Cook”, “Wash Dishes”, “Rest” and “Sleep” all correspond to different grayscale values. It should be noted that in the present embodiment, the candidate image features one-to-one correspond to the activities recognizable to the activity recognition system. Besides, a grayscale value difference between two image features corresponding to the activity pair ranked first in the arrangement sequence is greater than a grayscale value difference between two image features corresponding to the activity pairs not ranked first in the arrangement sequence. In an embodiment, the higher the rank of an activity pair in the arrangement sequence, the larger the difference between the grayscale values corresponding to respective activities with the largest probability among the previous activities of the two activities of the activity pair, such that the two different activities can be more clearly differentiated.

Thus, after the original activity image is obtained, 1 row (or 1 column) of pixels with the grayscale value representing the second activity (that is, the activity corresponding to the previous time point) is “added to” the original activity image to generate a characteristic activity image, such that the neural network can more accurately determine the current activity according to the added image feature (that is, the previous activity).

In an embodiment, a step S304 is provided between step S303 and step S305. In step S304, the arrangement sequence is adjusted according to an occurrence frequency of each activity. For a specific activity, the occurrence frequency represents the number of times for which the specific activity is performed by a user over several time points. For example, for the activity “Sleep”, the number of times for which the activity “Sleep” is performed by the user can be obtained by observing 1000 time points, and the rest activities can be obtained by the same analogy. Thus, the occurrence frequency of each activity can be obtained by observing the number of occurrences of each activity among the 1000 observations. For an activity with an occurrence frequency lower than a specific threshold (the specific threshold can be set according to actual needs), the activity may be mis-determined because the occurrence frequency of the activity is too low (the activity has a lower probability). Therefore, in step S304, the rank of one or more activity pairs containing the activity with an occurrence frequency lower than the specific threshold is adjusted forward. For example, the rank is adjusted to be higher than the activity pair with the largest similarity. In step S405, the image feature is allocated according to the adjusted arrangement sequence. In the above example, suppose the occurrence frequency of the activity “Sleep” is lower than the specific threshold. When performing step S304, the rank of the activity pair [“Sleep”-“Rest”], which has the largest similarity among all activity pairs containing the activity “Sleep”, is adjusted to be higher than the activity pair [“Go Home”-“Go Out”].

In an embodiment, in step S403, the activity pairs can be divided into several problem groups according to several similarity thresholds, then the arrangement sequence is decided according to the problem groups and the similarity thresholds. For example, 3 similarity thresholds are set as 70%, 50%, 30%, and 4 problem groups are set as a serious problem group, secondary problem group, ordinary problem group, and no problem group. In the present example, the activity pairs with a similarity between 71%˜100% are allocated to the serious problem group; the activity pairs with a similarity between 51%˜70% are allocated to the secondary problem group, and the rest activity pairs can be obtained by the same analogy. When deciding the arrangement sequence, the activity pairs in the serious problem group are ranked first, and the activity pairs in the secondary problem group are ranked second, and the activity pairs in the rest groups can be obtained by the same analogy.

In an embodiment, in step S403, the arrangement sequence can be adjusted according to the occurrence frequency and the similarity thresholds. For example, 4 problem groups are set as a serious problem group, primary problem group, secondary problem group, and no problem group, and 2 similarity thresholds are set as 70% and 50%. The activity pairs with an occurrence frequency lower than a specific threshold are allocated to the serious problem group; the activity pairs with a similarity between 71%˜100% are allocated to the primary problem group, the activity pairs with a similarity between 51%˜70% are allocated to the secondary problem group; and the rest activity pairs can be obtained by the same analogy. When deciding the arrangement sequence, the activity pairs in the serious problem group are ranked first, the activity pairs in the primary problem group, the secondary problem group, and the no problem group are ranked subsequently.

It should be noted that the order of steps as indicated in FIG. 2 is for explanatory purpose only, not for limiting the order by which the steps is performed. In practical application, the execution order of the steps can be adjusted according to actual needs. For example, the second time point of step S203 can be earlier than the first time point of step S201. Similarly, the order of steps as indicated in FIG. 4 is for explanatory purpose only, not for limiting the order by which the steps is performed.

In the above embodiments, for each activity pair, the allocation of image features considers the activity with the largest probability among the previous activities of the activity pair. In an alternate embodiment, for each activity pair, the allocation of image features can consider n activities with n largest probabilities among the previous activities of the activity pair, wherein n is an integer greater than 1. For example, in an embodiment, the activity pair ranked first in the arrangement sequence is considered, and the two activities with two largest probabilities among the previous activities of each of the two activities of the activity pair are found, and an image feature is allocated to the 4 activities respectively. Then, the activity pair ranked second in the arrangement sequence is considered, and the rest activity pairs can be obtained by the same analogy.

Through an embodiment of the present invention, the probability of mis-determining different activities as similar activities when similar sensors are triggered by different activities can be effectively reduced, such that the accuracy and safety of the activity recognition system can be increased.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An activity recognition method applied to an activity recognition system configured to recognize a plurality of activities, comprising:
obtaining an original activity image corresponding to a first time point, wherein the original activity image comprises a plurality of pixels indicating whether a plurality of sensors are triggered;
determining an image feature according to a second activity corresponding to a second time point, wherein the second time point is prior to the first time point;
integrating the original activity image and the image feature to generate a characteristic activity image; and
determining a first activity corresponding to the first time point according to the characteristic activity image.

2. The activity recognition method according to claim 1, wherein the image feature is determined from a plurality of candidate image features one-to-one corresponding to the activities, and a correspondence relation between the candidate image features and the activities is generated by:
pairing each activity with other activities respectively to form a plurality of activity pairs, and one by one calculating a similarity corresponding to each activity pair;
determining an arrangement sequence according to the similarities; and
allocating the activities to the candidate image features according to the arrangement sequence and a probability distribution of a previous activity of the activity.

3. The activity recognition method according to claim 2, further comprising determining which activity pair to be ranked first in the arrangement sequence, wherein for each activity pair, the step of allocating the activities to the candidate image features according to the arrangement sequence and a probability distribution of the previous activity of each activity comprises:
when the activity with the largest probability among the probability distribution of the previous activity of an activity of the activity pair does not have the corresponding candidate image feature, allocating the activity with the largest probability among the probability distribution of the previous activity of an activity of the activity pair to one of the candidate image features; and
when the activity with the largest probability among the probability distribution of the previous activity of the other activity of the activity pair does not have the corresponding candidate image feature, allocating the activity with the largest probability among the probability distribution of the previous activity of the other activity of the activity pair to the other one of the candidate image features.

4. The activity recognition method according to claim 2, wherein the candidate image features have different grayscale values.

5. The activity recognition method according to claim 2, wherein a grayscale value difference between a first candidate image feature and a second candidate image feature corresponding to the activity pair ranked first in the arrangement sequence is greater than a grayscale value difference between the first candidate image feature and the second candidate image feature corresponding to the activity pairs not ranked first in the arrangement sequence.

6. The activity recognition method according to claim 2, wherein after determining an arrangement sequence according to the similarities, the method further comprises:
adjusting the arrangement sequence according to an occurrence frequency of each activity.

7. The activity recognition method according to claim 6, wherein in the step of adjusting the arrangement sequence according to an occurrence frequency of each activity, a rank of one or more activity pairs comprising the activity with the occurrence frequency lower than a specific threshold in the arrangement sequence is moved forwards.

8. The activity recognition method according to claim 2, wherein when determining the arrangement sequence according to the similarities, the activity pairs are divided into a plurality of problem groups according to the similarities and a plurality of similarity thresholds, then the arrangement sequence is determined according to the problem groups and the similarities.

9. A computer-readable media, wherein when the computer-readable media is performed by a processing unit of an activity recognition system configured to recognize a plurality of activities, the processing unit is enabled to:
obtain an original activity image corresponding to a first time point, wherein the original activity image comprises a plurality of pixels indicating whether a plurality of sensors are triggered;
determine an image feature according to a second activity corresponding to a second time point, wherein the second time point is prior to the first time point;
integrate the original activity image and the image feature to generate a characteristic activity image; and
determine a first activity corresponding to the first time point according to the characteristic activity image.

10. The computer-readable media according to claim 9, wherein the image feature is determined from a plurality of candidate image features one-to-one corresponding to the activities, and a correspondence relation between the candidate image features and the activities is generated by:
pairing each activity with other activities respectively to form a plurality of activity pairs, and one by one calculating a similarity corresponding to each activity pair;
determining an arrangement sequence according to the similarities; and
allocating the activities to the candidate image features according to the arrangement sequence and a probability distribution of a previous activity of the activity.

11. The computer-readable media according to claim 10, further comprising determining the activity pair ranked first in the arrangement sequence, wherein for each activity pair, and allocating the activities to the candidate image features according to the arrangement sequence and a probability distribution of the previous activity of the activity comprises:
when the activity with the largest probability among the probability distribution of the previous activity of an activity of the activity pair does not have the corresponding candidate image feature, allocating the activity with the largest probability among the probability distribution of the previous activity of an activity of the activity pair to one of the candidate image features; and
when the activity with the largest probability among the probability distribution of the previous activity of the other activity of the activity pair does not have the corresponding candidate image feature, allocating the activity with the largest probability among the probability distribution of the previous activity of the other activity of the activity pair to the other one of the candidate image features.

12. The computer-readable media according to claim 10, wherein the candidate image features have different grayscale values.

13. The computer-readable media according to claim 10, wherein a grayscale value difference between a first candidate image feature and a second candidate image feature corresponding to the activity pair ranked first in the arrangement sequence is greater than a grayscale value difference between the first candidate image feature and the second candidate image feature corresponding to the activity pairs not ranked first in the arrangement sequence.

14. The computer-readable media according to claim 10, wherein after determining an arrangement sequence according to the similarities, further comprises:
adjusting the arrangement sequence according to an occurrence probability of each activity.

15. The computer-readable media according to claim 14, wherein adjusting the arrangement sequence according to an occurrence frequency of each activity comprises moving a rank of one or more activity pairs comprising adjusting the activity with the occurrence frequency lower than a specific threshold in the arrangement sequence forwards.

16. The computer-readable media according to claim 10, wherein when determining the arrangement sequence according to the similarities, the activity pairs are divided into a plurality of problem groups according to the similarities and a plurality of similarity thresholds, then the arrangement sequence is determined according to the problem groups and the similarities.
